(19) United States
(12) Patent Application Publication
(10) Pub. No.: US 2011/0115907 A1
(43) Pub. Date: May 19, 2011

(54) Safe visions

(76) Inventor: Rory Glenn Cameron, Royse City, TX (US)

(21) Appl. No.: 12/806,388

(22) Filed: Aug. 12, 2010

Related U.S. Application Data
(60) Provisional application No. 61/246,652, filed on Sep. 29, 2009.

(51) Int. Cl. H04N 7/18

(52) U.S. Cl. 348/143; 348/E07.085

(57) ABSTRACT

A video monitoring system for a vehicle includes an LCD display mounted within the interior of an elevator, preferably adjacent to the elevator control panel. A plurality of wide-angle cameras are strategically positioned on each floor, preferably above the elevator access door. The cameras continuously records images near the elevator access door and transmit the images to a central computer for manipulation and storage. The controlling computer and display are also in communication with the elevator's control system. Accordingly, when a rider depresses the button corresponding to the desired destination floor, images captured by the corresponding camera are depicted on the display located in the elevator cab. If the rider observes an unsafe situation, he or she may stop at another floor.

This application for Utility patent Claim takes priority from Provisional Application File No. 61/246,652 listed under Title of Invention: Elevator Monitoring System.

### BACKGROUND OF THE INVENTION

The present invention relates to a video monitoring system that allows an elevator passenger to view all live images of a destination floor.

### DESCRIPTION OF THE PRIOR ART

Elevator passengers typically depress a button that instructs the elevator to stop at a desired floor. Once the elevator door opens, the rider may be unwittingly exposed to a potential attacker or another undesirable situation. Conventional elevators, however, include no means for a rider to survey a destination floor prior to arrival to determine if a potentially dangerous situation exists. Accordingly, there is currently a need for a device that improves the safety of elevator passengers. The present invention addresses this need providing a video monitoring system for an elevator that allows a rider to view live video images of a destination floor so that corrective action may be taken if a potentially dangerous situation is observed.

### SUMMARY OF THE INVENTION

The present invention relates to a video monitoring system for a vehicle comprising an LCD display mounted within the interior of an elevator, preferably adjacent to the elevator control panel. A plurality of wide-angle cameras are strategically positioned on each floor, preferably above the elevator access door. The cameras continuously record images near the elevator access door and transmit the images to a central computer for manipulation and storage. The controlling computer and display are also in communication with the elevator's control system. Accordingly, when a rider depresses the button corresponding to a destination floor, images captured by the corresponding cameras are depicted on the display within the elevator cab. If the rider observes an unsafe situation, he or she may stop the elevator at another floor. It is therefore an object of the present invention to provide a monitoring system for elevator passengers. Other objects, features and advantages of the preferred embodiment when considered with the attached drawings and the appended claims.

The “Safe Visions” is an innovative security product that has been designed to provide the elevator rider the opportunity to look at the area around the elevator access door on the floor where they plan to get off. The building has wide angle cameras mounted above the elevator doors on each floor and a monitor in the elevator that shows the selected floor's exit/access area. If there are any potential security issues there, the elevator can be stopped on the floor below and security notified by the rider(s). In today's elevators, the rider gets on, pushes the button for their floor and whatever is on the exit landing is what they face when they get there. The perpetrators hang around at the landing and if a single male or female gets off, they can rob or molest them or can take their keys from them and rob or vandalize their apartment. The rider has no knowledge of the perpetrators and is, most often, taken by surprise as they exit the elevator, believing they are safe in the building. The “Safe Visions” resolves most of these problems. A wide angle camera is placed above the doors at each access/exit landing. The camera observes the landing and transmits a full color CCTV (closed circuit television) signal to the hub. When the floor's button is pushed in the elevator, that floor's landing is displayed on the large monitor in the elevator so the rider can see what the activity is on that landing. If the access/exit point looks safe, the elevator is allowed to stop at the selected floor normally.

If the landing does not look safe, the rider has 3 options; 1) the elevator can be stopped on the floor below if it looks safe or, 2) the elevator can be stopped using the emergency stop button and, 3) the building security people can be called using the internal microphone and speaker link on the elevator's control panel. When multiple people ride on the elevator, the numerically lowest selected floor is shown first, then the next upward in sequence, finally the last. The controlling computer hub selects the views for display and also records them to digital media for security review. As an alternative, the monitor can be programmed into the ‘split screen’ mode, which will allow the computer to show the nearest selected floor on the left half of the screen and the next higher in numerical sequence on the right half. This split screen approach allows multiple riders the time to take other action rather than just having to press the emergency stop button. This programming can also be taken to the ‘quad split screen’ mode where the multiple rider's selected floors are shown in 4 images, which are then incremented upward as the riders get off. The system uses the latest in commercially available equipment for the application. The latest in vandal resistant wide angle, low light cameras are employed. The polycarbonate housings and transparent lenses will absorb very large impacts without degradation. The digital signal is converted at the camera and the CCTV signal is just switched by the computer to the monitor in the elevator so the rider can see exactly what the camera is viewing in full color. The camera also has an audio stream that can be engaged if security is alerted. The minimum specifications are listed in the table below.

| Specifications | Details |
|---|---|
| Image sensor | ¼″ progressive scan RGB CMOS |
| Lens | Varifocal, DC iris, remote focus and |
| | zoom |
| Day & night | Typical lighting in day, IR at night |
| Minimum illumination | Color: 0.2 LUX F1.2, B/W 0.04 LUX |
| | F1.2 |
| Video compression | H.264 (MPEG 4 part 10/AVC) |
| Frame rate | 30 fps in all resolutions |

The controlling computer is a typical computer with monitor attached to a server, if the volume of video is going to be larger than a typical computer can handle. For most 10 story residential units a typical computer can be used. It is connected to each of the cameras located at the elevator access/exit point. The digital signal from the cameras are stored momentarily, a few microseconds, and then routed to the monitor in elevator as the floors are selected. (The minimum computer specifications are listed in the table below). For the security storage, a snapshot is taken every 6 seconds from every floor in sequence and is stored in that floor's file. The most current computers and the latest in video capture, digital video conversion, and digital storage are used to make this action seamless. The digital storage holds the security footage for 24 hours before writing over the images. Anytime before being written over, they can be downloaded to DVD or other storage media manually.

| Specifications | Details |
|---|---|
| Processors | 2 dual core Intel Zeon processors E5502, |
| | 1.86 GHz, 4M, L3, 4.8 GT/s |
| Memory | 4 GB, DDr3 Memory, 1066 MHz, ECC |
| Graphics | 512 MB, NVIDIA Quadro NVS 420 |
| Hard drive | 300 GB SATA, 10K rpm, 16 GB cache |
| External hard drive | 500 GB |
| Operating system | Windows XP professional |
| Monitor | 22″ flat panel, ultra sharp |
| Keyboard | Quietkey keyboard |
| Mouse | Optical mouse |
| Ports | 4 external USB, 10/100T Ethernet |
| Power | 120 VAC |

The 13″ vandal-resistant monitor is located in the internal section of the elevator and mounted just above the standard elevator control panel. The panel is mounted and set up. Automatic controls keep it in adjustment thereafter. The front of the screen is protected with a polycarbonate screen. (The minimum monitor specifications are listed in the table below).

| Specifications | Details |
|---|---|
| Display | 13″ TFT LCD panel, N mode, normally |
| | white |
| Signal System | 525 lines NTSC, 625 lines PAL |
| Aspect ratio | 5:4 |
| Pixel pitch | 0.51 mm by 0.51 mm |
| Display resolution | 800 by 600 |
| Contrast | 500:1 typical |
| Brightness | 500 cd/m² typical |
| Response time | 16 ms |
| Display mode | Video, Y/C, S video, VGA |
| Connections | 15 pin D sub, BNC (2), RCA (2) |
| Input voltage | 96 to 256 VAC, 50 or 60 Hz |

The electronic feed lines to and from the elevator is supported and dressed to operate for several years without degradation. All of the video signals are transmitted on an Ethernet cable using the IEEE 802.3af network. All other control cables used will meet all applicable federal and state elevator codes. The product is designed to be aesthetic and effective in the application. The relative ease of manufacture and the inexpensive components provide good marketability for the manufacturer. The rider benefits from a safe exit from the elevator and the building management benefits from dramatically reduced theft, vandalism, and molestation, which should provide considerable market interest in the product. The invention is illustrated in the four drawings of the essential points as explained to us in the documentation.

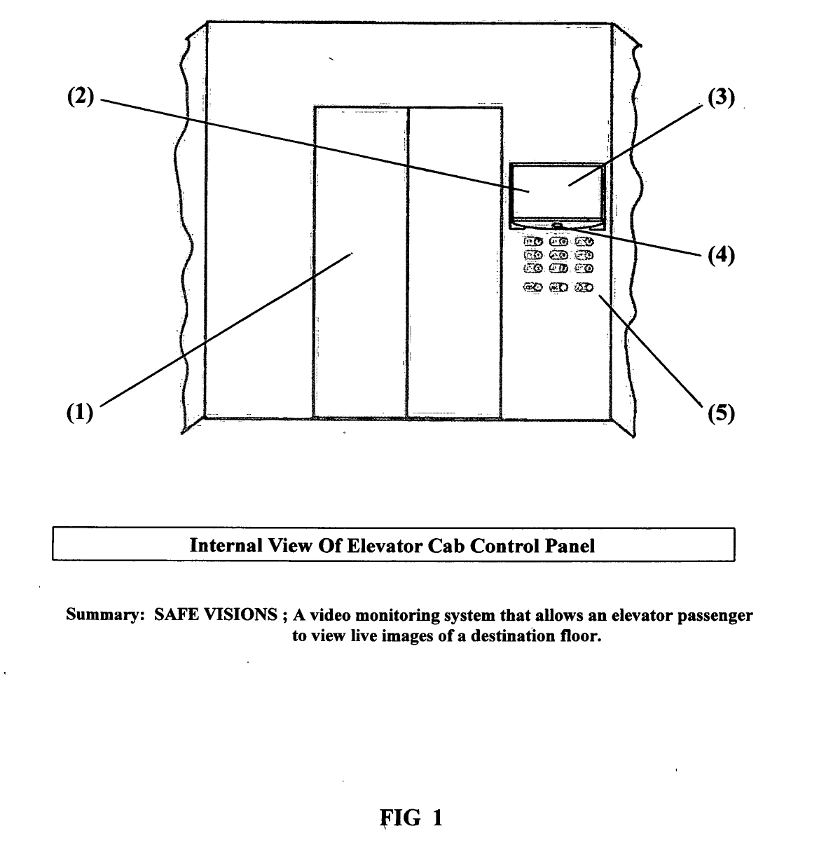

### FIG. 1, Safe Visions—Internal View of Elevator Control Panel

(1) Typical elevator with the product installed. The product can be used in any residential or commercial building. However, the residential application is defined in this document.

(2) When the rider selects the floor, the real time image of the user selected hallway access point is displayed. A wide angle camera is placed above the doors at each access/exit landing. The camera observes the landing and transmits a full color CCVT (closed circuit television) signal to the hub. When the floor's button is pushed in the elevator, that floor's landing is displayed on the large monitor in the elevator so the rider can see what the activity is on the landing. If the access/exit point looks safe, the elevator is allowed to stop at the selected floor normally. If the landing does not look safe, the rider has 3 options; 1) the elevator can be stopped on the floor below if it looks safe or, 2) the elevator can be stopped using the emergency stop button and, 3) the building security people can be called using the internal microphone and speaker link on the elevator's control panel. When multiple people ride on the elevator, the numerically lowest selected floor is shown first, then the next upward in sequence, finally the last. The controlling computer hub selects the views for display and also records them to digital media for security review.

(3) If the hallway access point is free of potential danger, the rider does nothing. The elevator proceeds to the selected floor and the doors open normally.

(4) If the hallway access point has some potential danger, the emergency stop is pressed and the elevator stops 1 floor below.

(5) If there are several riders, the hallway access points are displayed in ascending order.

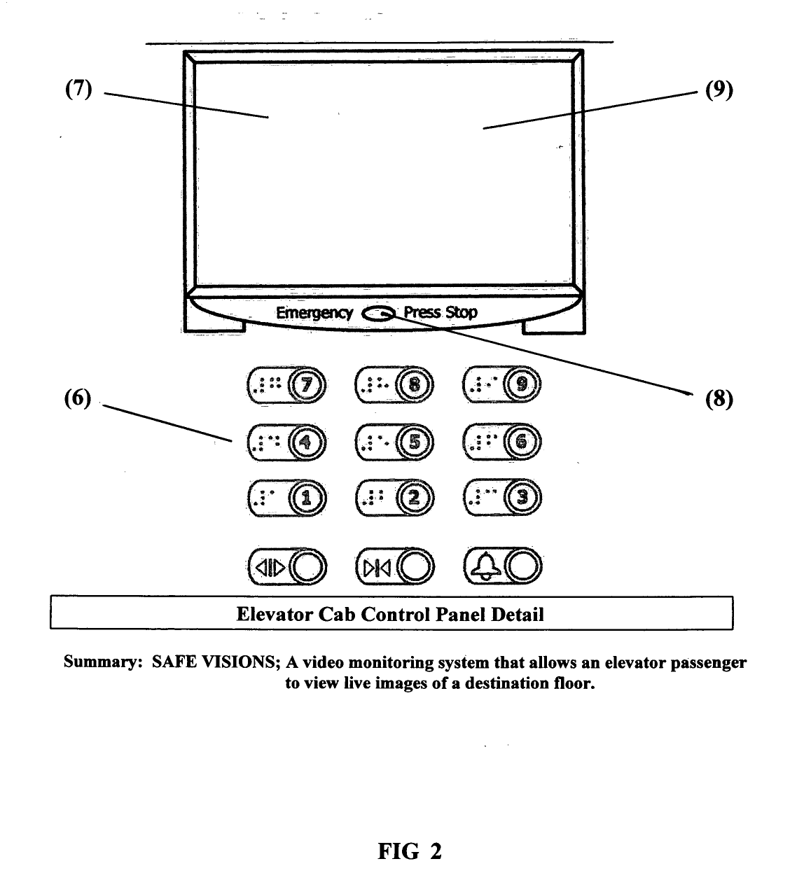

### FIG. 2, Safe Visions—Elevator Cab Control Panel Detail

(6) The standard floor selection and elevator control panel is not altered in any way. The floor selection information is copied from the elevator controller and transferred to the “Safe Visions” controlling computer. The only action that the “Safe Visions” computer has with the elevator control is the “emergency stop” button in the monitor. If that button is pressed, the elevator automatically stops at the floor below the one selected and allows the passengers to get off.

(7) The vandal resistant color monitor is secured to the internal wall of the elevator above the control panel.

(8) The emergency stop on the monitor stops the elevator one floor below that displayed and alerts internal security that they have a problem on the “X” floor.

(9) This visual system prevents assaults, robberies, muggings, and can result in the apprehension of criminals.

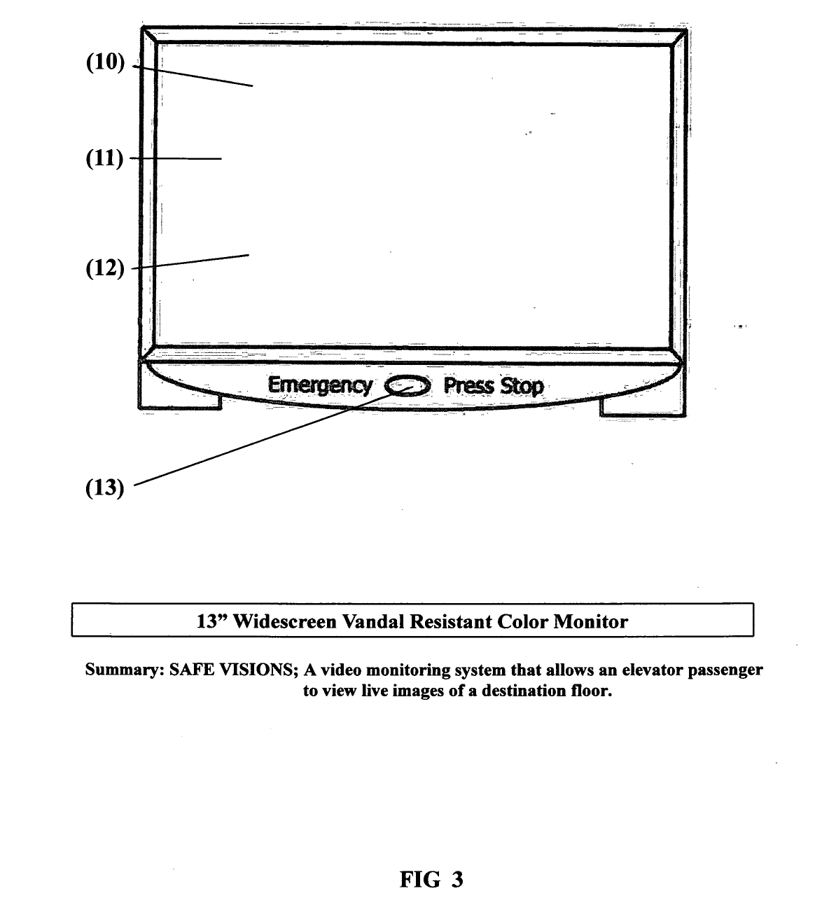

### FIG. 3, Safe Visions—13″ Widescreen Vandal-Resistant Color Monitor

(10) The LCD monitor is stylish and uses a polycarbonate face shield to protect the LCD electronics. The 13″ vandal-resistant monitor is located in the internal section of the elevator and mounted just above the standard elevator control panel. The panel is mounted and set up.

Automatic controls keep it in adjustment thereafter. The front of the screen is protected with a polycarbonate screen.

(11) The monitor is set for color and clarity when installed and the automatic controls maintain the optimum image clarity.

(12) The 13″ monitor is large enough for most commercial carrying elevators and the images can be clearly seen from anywhere in the cabin.

(13) The emergency stop button is tied into the elevator controls and the security system and the computer nexus. The controlling computer is a typical computer with monitor attached to a server, if the volume of video is going to be larger than a typical computer can handle. For most 10 story residential unit's a typical computer can be used. It is connected to each of the cameras located at the elevator access/exit point. The digital signal from the cameras are stored momentarily, a few microseconds, and the routed to the monitor in elevator as the floors are selected. (The minimum computer specifications are listed in the table below). For the security storage, a snapshot is taken every 6 seconds from every floor in sequence and is stored in that floor's file. The most current computers and the latest in video capture, digital video conversion, and digital storage are used to make this action seamless. The digital storage holds the security for 24 hours before writing over the images. Anytime before being written over, they can be downloaded to DVD or other storage media manually.

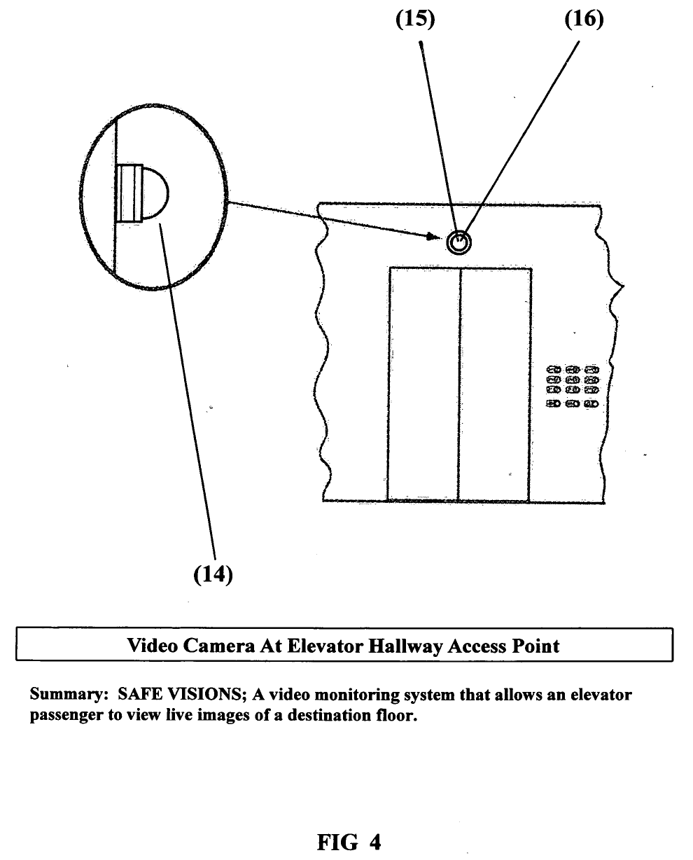

### FIG. 4, Safe Visions—Video Camera at Hallway Access Point

(14) Vandal proof wide angle camera uses typical room light to normally provide color images and can use the internal infrared illuminators if the hallway lights are off or vandalized. The system uses the latest in commercially available equipment for the application. The latest in vandal resistant wide angle, low light cameras are employed. The polycarbonate housings and transparent lenses will absorb very large impacts without degradation. The digital signal is converted at the camera and the CCTV signal is just switched by the computer to the monitor in the elevator so the rider can see exactly what the camera is viewing in full color. Each camera also has an audio stream that can be engaged if security is altered.

(15) The camera is installed above the door of the elevator and can provide images at and around the elevator access point so the rider can determine whether a security issue exists or not.

(16) The digital images are sent to the controlling computer via the Ethernet IEEE 802.3af network. This network cable also brings power to the cameras so the installation requires fewer cabling during the installation.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

What is claimed is:

1. Video monitoring system controlled and utilized by a cab elevator passenger.

2. Video monitoring system that allows an elevator passenger to view live images of a destination floor.
